(19) United States
(12) Patent Application Publication
(10) Pub. No.: US 2015/0260878 A1
(43) Pub. Date: Sep. 17, 2015

(54) Hydrophone Response Compensation Filter Derivation, Design and Application

(71) Applicant: Geokinetics Acquisition Company, Houston, TX (US)

(72) Inventors: Miller Lee Bell, Houston, TX (US); John Frederic Parrish, Houston, TX (US); Nicolau Palm, Bocaina de Minas (BR)

(21) Appl. No.: 14/644,073

(22) Filed: Mar. 10, 2015

Related U.S. Application Data
(60) Provisional application No. 61/950,663, filed on Mar. 10, 2014.

(51) Int. Cl. G01V 13/00; G01V 1/38; G01V 1/30; G01V 1/18; G01V 1/36

(52) U.S. Cl. CPC G01V 13/00; G01V 1/186; G01V 1/36; G01V 1/30; G01V 1/3808; G01V 2210/59; G01V 2210/60

(57) ABSTRACT

A method to derive, design and apply digital signal filters to compensate for variations in hydrophone sensitivity. The impedance or resonance of a hydrophone is measured and compared respectively to the impedance or resonance values from a library of hydrophone responses containing values for impedance, resonance, amplitude sensitivity, phase response, or other hydrophone characteristics. A corrective filter is determined based on library values, and this filter is applied to the data collected by the hydrophone.

### RELATED APPLICATION

This application claims priority from U.S. Provisional Patent Application No. 61/950,663, filed Mar. 10, 2014, entitled “Hydrophone Response Compensation Filter Derivation, Design and Application,” pending.

### FIELD

The present invention relates to the field of seismic exploration, and more particularly to the field of seismic data quality and methods for improving seismic data quality. Most particularly, the present invention relates to methods for improving response of acoustic sensors, and especially hydrophones.

### SUMMARY

The present invention provides a method for improving seismic data quality by correcting and compensating for variations in the amplitude and phase performance of hydrophones. According to one embodiment of the method of the invention, the impedance of a hydrophone is measured and compared to the impedance values from a library of hydrophone responses containing values for impedance, amplitude sensitivity, phase response, or other hydrophone characteristics. A corrective filter is determined based on the library values and this filter is applied to the data collected by the hydrophone.

According to an alternative embodiment of the method of the invention, the resonance of a hydrophone is measured and compared to the resonance values from a library of hydrophone responses containing values for resonance, impedance, amplitude sensitivity, phase response or other hydrophone characteristics. A corrective filter is determined based on the library values and this filter is applied to the data collected by the hydrophone.

### BRIEF DESCRIPTION OF FIGURES

FIG. 1 is a graph of hydrophone sensitivity curves from a hydrophone manufacturer's specifications, showing the variation of sensitivity as a function of frequency.

FIG. 2 is a graph of hydrophone phase curves from a hydrophone manufacturer's specifications, showing the variation of phase as a function of frequency.

FIG. 3 is a graph of measured hydrophone sensitivity curves, plotting hydrophone impedance versus frequency.

FIG. 4 shows an equivalent circuit of two sensor elements where the impedance across output terminals has the same resonant frequency and damping as natural step response and sensitivity.

FIG. 5 is a graph of computed impedance versus frequency for a hydrophone.

FIG. 6 provides response details for a hydrophone showing a hydrophone impulse response and then the impulse after compensation according to the invention.

### DESCRIPTION

In the field of seismic exploration, sensitive acoustic sensors are used to detect the acoustic energy at or near the earth's surface and convert that acoustic energy to electrical or optical signals that can then be recorded for further analysis. It is well known in the field that seismic data quality is improved if the responses of all of the acoustic sensors to the acoustic energy are identical. One such type of detector commonly used in the field is known as a hydrophone.

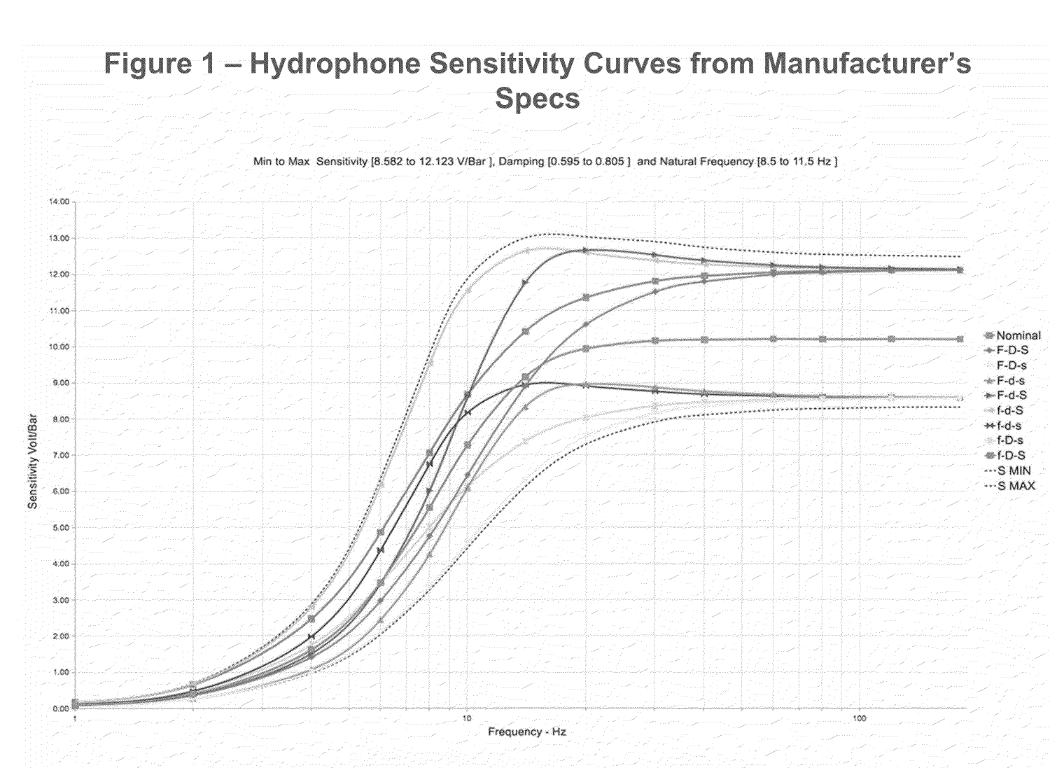

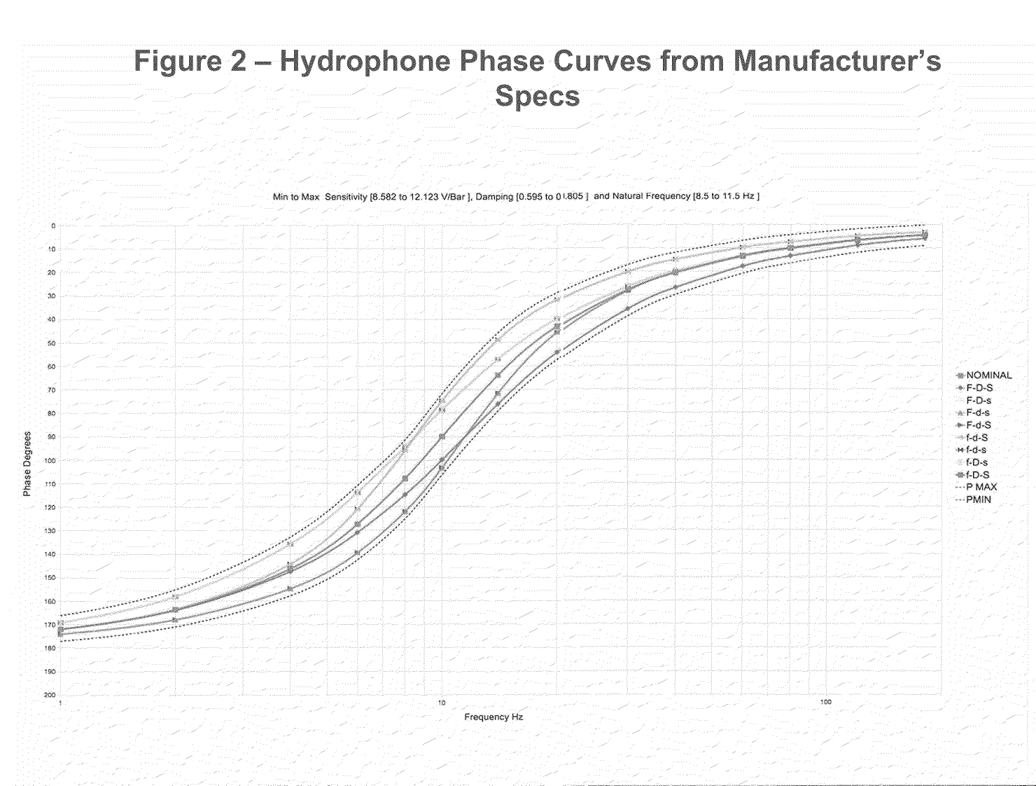

Research has shown that the output sensitivity of seismic hydrophones can display significant, frequency dependent variations in amplitude and phase as a result of the natural life cycle of the unit, proximity to airgun and dynamite acoustic sources, variations in water depth, electrical leakage and unspecified trauma induced events. In addition, there are a wide range of sensitivity values which fall within the manufacturer's published tolerance specifications. FIG. 1 shows the variation of the sensitivity as a function of frequency. Over a typical frequency range used in seismic acquisition (10-70 Hz), the variations can be nearly a factor of 2. FIG. 2 shows the same for the phase. Again over the frequency range of interest there are variations of 30 degrees. These variations in sensitivity can be detrimental to the fidelity of seismic data collected using these hydrophones.

The present invention provides a method to derive, design and apply digital signal filters to compensate for the variations in hydrophone sensitivity.

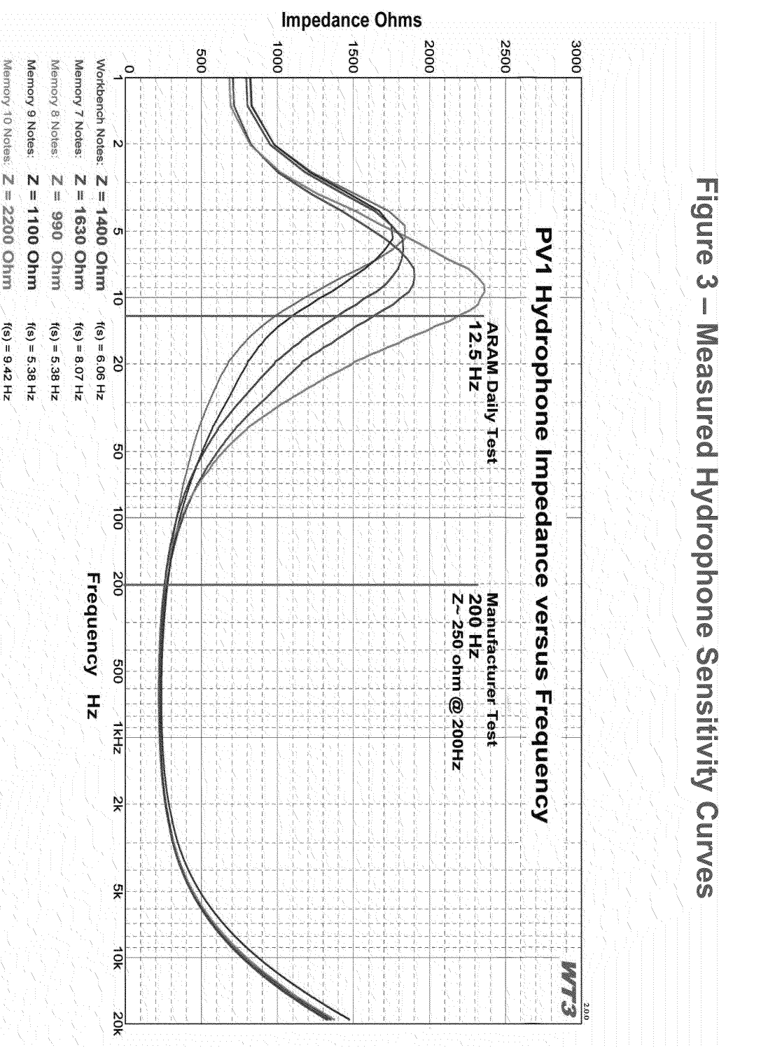

Hydrophone sensitivity can be tested and measured using a broadband hydrophone analyzer or other instrument that accurately maps the amplitude sensitivity and phase of the hydrophone output across the entire seismic bandwidth. This measurement results in a response curve that displays the variation of the hydrophone output from the nominal standard output. These measurements are time consuming and are best performed in a laboratory setting. FIG. 3 shows an example of five such measurements of impedance, which is directly related to the hydrophone sensitivity. Again a large variation in both the natural resonance frequency and the amplitudes can be seen. For reference, the manufacturer's testing frequency at 200 Hz is displayed, a measurement well beyond frequencies used in seismic acquisition.

According to one embodiment of the present invention, there is a computable relationship between the measured complex impedance of an individual hydrophone and its output amplitude sensitivity and phase. The impedance of a hydrophone can be measured before, after, or during field deployment of a sensor and does not require the time and expense of laboratory measurements.

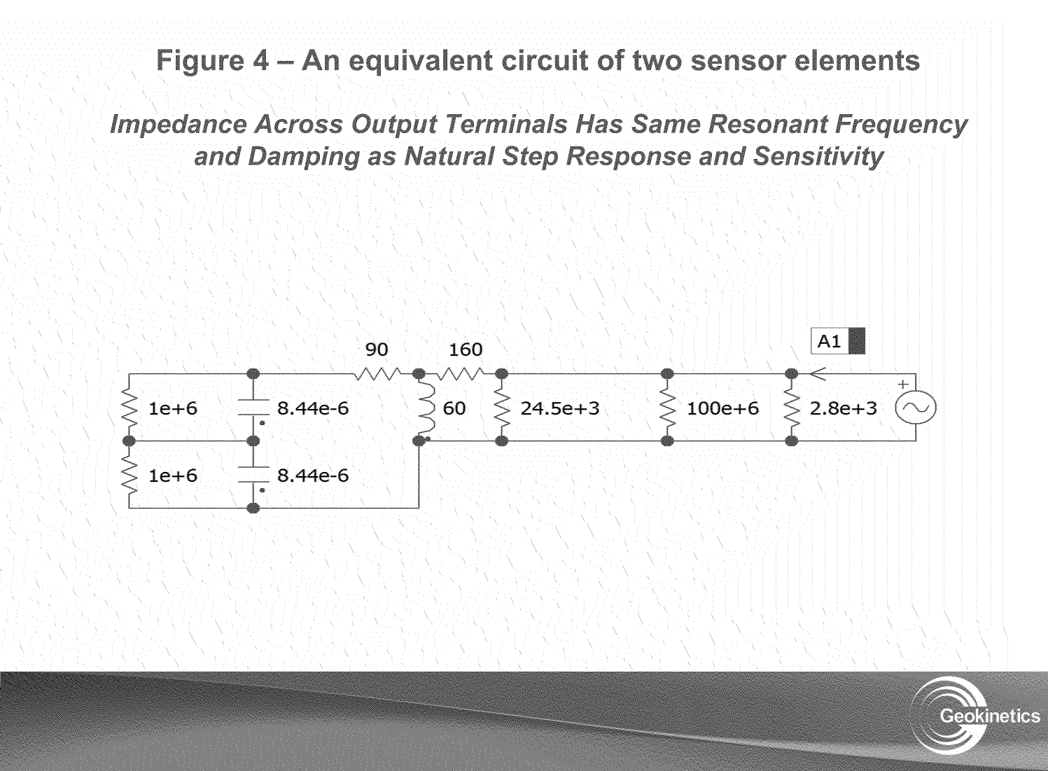

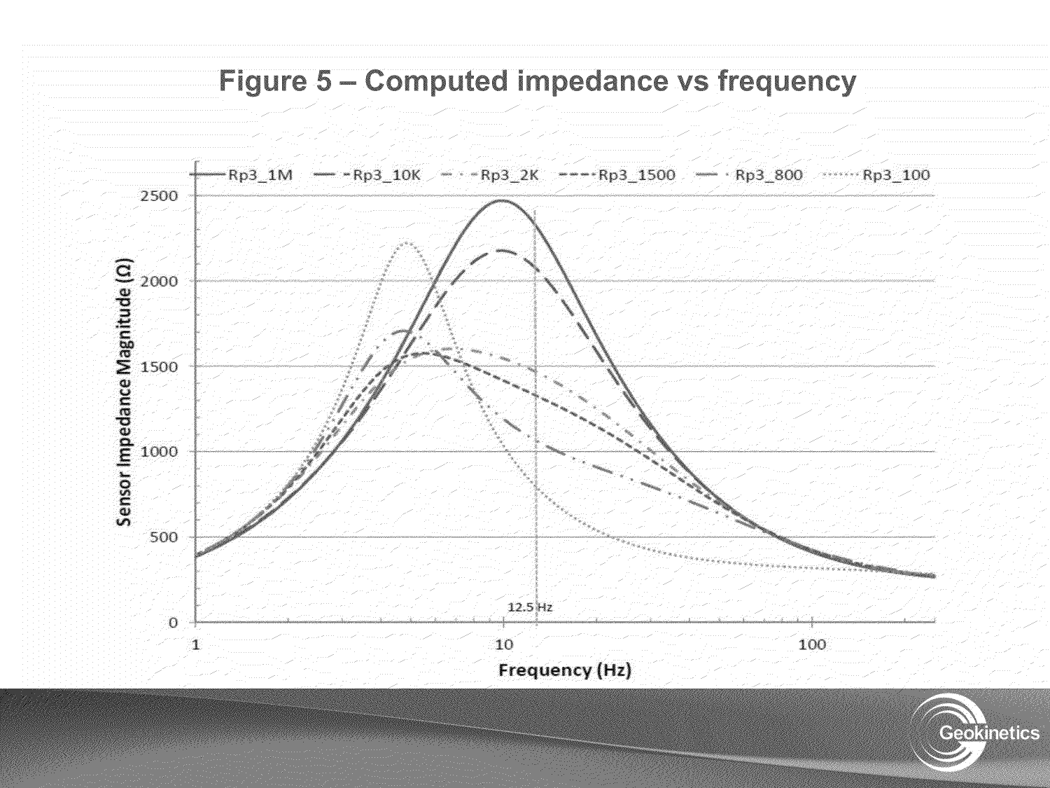

Sensor impedance can be measured by several different procedures including but not limited to: step response, impulse response, swept frequency measurements, natural response resulting from initial conditions, etc. An observed impedance response shares natural resonances with its hydrophone pressure sensitivity response. Other aspects of impedance and sensitivity responses can differ significantly. Nevertheless, an equivalent electrical circuit of a sensor can be combined with its observed impedance response to compute its amplitude and phase sensitivity. This is illustrated in FIGS. 4 and 5. FIG. 4 shows a schematic of a two-element hydrophone circuit. By varying the resister values the behavior of hydrophones may be modeled as shown in FIG. 5.

When such an impedance response is measured for each sensor, then its associated amplitude and phase sensitivity response can be used to compute an equalization or corrective filter that can make all of the seismic data traces have the same output response, thereby improving the quality of the recorded seismic data. The equalization or corrective filter is determined by a method of matching filter design, such as, for example, Wiener Filter Optimization.

In an alternative embodiment of the invention, resonance of a hydrophone instead of (or in addition to) impedance is determined and compared to known resonance values for hydrophones. A corrective filter is determined based on known values and the corrective filter is applied to the data collected by the hydrophone. The corrective filter may be determined by Wiener Filter Optimization for example or by another method of matching filter design.

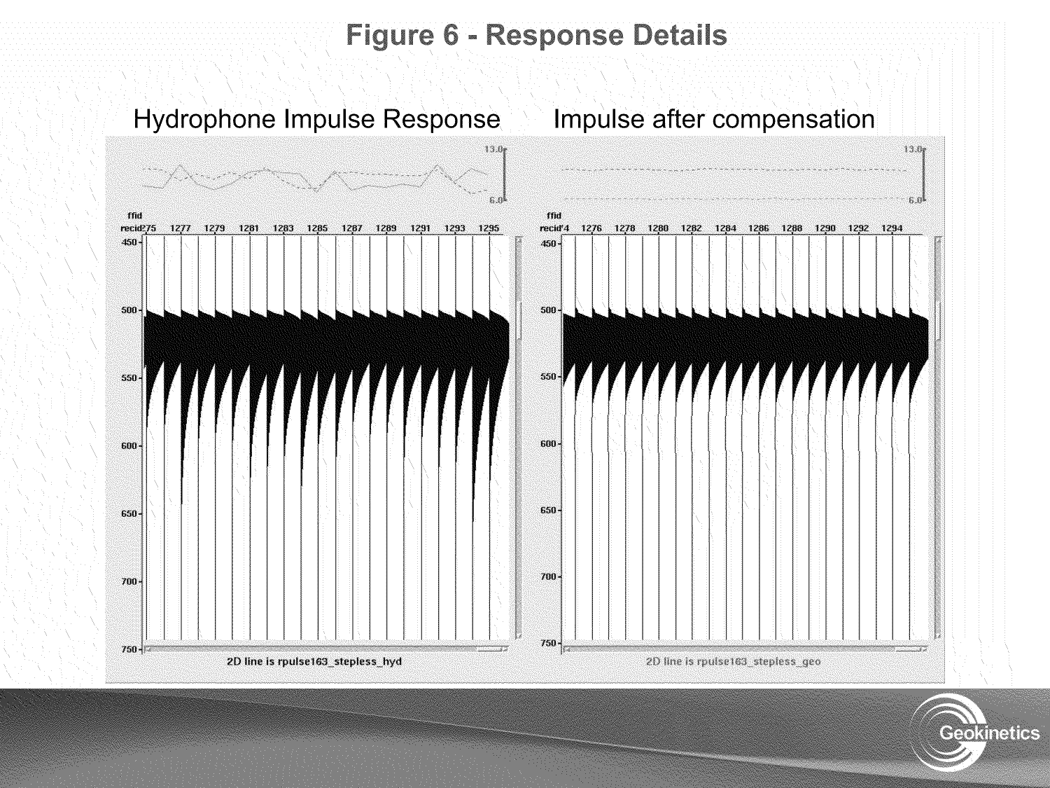

FIG. 6 illustrates the advantages provided by the invention. On the left hand side, the response of several hydrophones from an input step function is displayed. The variation of the amplitudes and phases of each of the hydrophones significantly distorts the acquired seismic data. On the right hand side, the hydrophone responses after compensation filters derived from the measurements are shown. The uniformity of the responses is now improved substantially.

It is important to recognize that the timing of the generation and application of the compensation is not relevant to the invention. The filter can be designed before, during, or after the seismic acquisition and the application of the filter can occur immediately after the hydrophone senses the acoustic signal, after the completion of data acquisition, during data processing, or at any point in between.

Accordingly, while there has been shown and described a preferred embodiment of the present invention, it is to be appreciated that the invention may be embodied otherwise than is herein specifically shown and described, and that within such embodiment, certain changes may be made in the form and arrangement of the parts without departing from the underlying ideas or principles of this invention, as defined by the following claims.

What is claimed is:

1. A method for improving seismic data quality by correcting and compensating for variations in the amplitude and phase performance of hydrophones, the method comprising:
a. determining the impedance of the hydrophones;
b. comparing the determined impedance to known impedance values for hydrophones;
c. determining a corrective filter based on the known values and applying the corrective filter to the data collected by the hydrophone.

2. The method of claim 1 wherein the known values are from a library of hydrophone responses containing values for impedance, amplitude sensitivity, phase response or other hydrophone characteristics.

3. The method of claim 1 wherein the impedance of the hydrophone is determined by direct measurement.

4. The method of claim 1 where in the impedance of the hydrophone is determined from analysis of a pulse or step voltage applied to the hydrophone for test purposes.

5. The method of claim 1 wherein the impedance of the hydrophone is obtained from routine daily impulse tests.

6. The method of claim 1 wherein the various relevant hydrophone attributes are determined from an impedance spectrum analysis of the hydrophone and these attributes are used to directly determine the best fit correction from the response library.

7. The method of claim 1 wherein the impedance of the hydrophone is measured and the corrective filter determined prior to data acquisition and applied as the data are being acquired by the hydrophone.

8. The method of claim 1 wherein the impedance of the hydrophone is measured and the corrective filter determined and applied after data acquisition.

9. The method of claim 1 wherein the corrective filter is determined by a method of matching filter design.

10. The method of claim 9 wherein the corrective filter is determined by Wiener Filter Optimization.

11. The method of claim 2 wherein the library of hydrophone responses containing values for impedance, amplitude sensitivity, phase response or other hydrophone characteristics is obtained through testing of a variety of hydrophones or other empirical tests on the hydrophones.

12. The method of claim 2 wherein the library of hydrophone responses containing values for impedance, amplitude sensitivity, phase response or other hydrophone characteristics is obtained through equivalent circuit or other theoretical calculations.

13. The method of claim 2 wherein the library of hydrophone responses containing values for impedance, amplitude sensitivity, phase response or other hydrophone characteristics consists of one or more equations used to calculate the relevant values.

14. A method for improving seismic data quality by correcting and compensating for variations in the amplitude and phase performance of hydrophones, the method comprising:
a. determining and assessing at least one resonance of the hydrophone;
b. comparing the determined resonance to known resonance values for hydrophones;
c. determining a corrective filter based on known values and applying the corrective filter to the data collected by the hydrophone.

15. The method of claim 14 wherein the known values are from a library of hydrophone responses containing values for resonance, impedance, amplitude sensitivity, phase response or other hydrophone characteristics.

16. The method of claim 14 wherein the resonance is determined by electrical changes in the hydrophone.

17. The method of claim 14 wherein the resonance is determined by the response to pressure changes in the hydrophone.

18. The method of claim 14 wherein the resonance of the hydrophone is determined by direct measurement.

19. The method of claim 14 where in the resonance of the hydrophone is determined from analysis of a pulse or step voltage applied to the hydrophone for test purposes.

20. The method of claim 14 wherein the resonance of the hydrophone is obtained from routine daily impulse tests.

21. The method of claim 14 wherein the various relevant hydrophone attributes are determined from a resonance spectrum analysis of the hydrophone and these attributes are used to directly determine the best fit correction from the response library.

22. The method of claim 14 wherein the resonance of the hydrophone is measured and the corrective filter determined prior to data acquisition and applied as the data are being acquired by the hydrophone.

23. The method of claim 14 wherein the resonance of the hydrophone is measured and the corrective filter determined and applied after data acquisition.

24. The method of claim 14 wherein the corrective filter is determined by a method of matching filter design.

25. The method of claim 24 wherein the corrective filter is determined by Wiener Filter Optimization.

26. The method of claim 14 wherein the corrective filter is determined by establishing an equalization filter that shifts a determined resonance of a hydrophone to match the resonance of the desired hydrophone response.

27. The method of claim 15 wherein the library of hydrophone responses containing values for resonance, impedance, amplitude sensitivity, phase response or other hydrophone characteristics is obtained through testing of a variety of hydrophones or other empirical tests on the hydrophones.

28. The method of claim 15 wherein the library of hydrophone responses containing values for resonance, impedance, amplitude sensitivity, phase response or other hydrophone characteristics is obtained through equivalent circuit or other theoretical calculations.

29. The method of claim 15 wherein the library of hydrophone responses containing values for resonance, impedance, amplitude sensitivity, phase response or other hydrophone characteristics consists of one or more equations used to calculate the relevant values.
